(19) United States
(12) Patent Application Publication
(10) Pub. No.: US 2021/0308808 A1
(43) Pub. Date: Oct. 7, 2021

(54) SOLDER ALLOY, SOLDER POWDER, SOLDER PASTE, AND A SOLDER JOINT USING THESE

(71) Applicant: SENJU METAL INDUSTRY CO., LTD., Adachi-ku, Tokyo (JP)

(72) Inventors: Hiroyoshi Kawasaki, Tokyo (JP); Osamu Munekata, Tokyo (JP); Masato Shiratori, Tokyo (JP)

(73) Assignee: SENJU METAL INDUSTRY CO., LTD., Adachi-ku, Tokyo (JP)

(21) Appl. No.: 17/261,557

(22) PCT Filed: May 27, 2019
(86) PCT No.: PCT/JP2019/020855

§ 371 Date: Jan. 19, 2021

(30) Foreign Application Priority Data
Jul. 20, 2018 (JP) 2018-136543

(51) Int. Cl. B23K 35/26; B23K 35/02; C22C 13/02; B23K 35/36

(52) U.S. Cl. CPC B23K 35/262; B23K 35/3601; C22C 13/02; B23K 35/025

(57) ABSTRACT

A solder alloy has an alloy composition of As: 25 mass ppm to 300 mass ppm, Bi: 0 mass ppm or more and 25000 mass ppm or less, and Pb: more than 0 mass ppm and 8000 mass ppm or less, with a balance being made up of Sn, the solder alloy satisfying Expression (1) and Expression (2) below,

275≤2As+Bi+Pb (1)

0<2.3×10⁻⁴×Bi+8.2×10⁻⁴×Pb≤7 (2)

where in Expression (1) and Expression (2), As, Bi and Pb represent respectively contents (mass ppm) thereof in the alloy composition.

### TECHNICAL FIELD

The present invention relates to a solder alloy, a solder powder, a solder paste and a solder joint utilizing the foregoing, in which changes in a paste over time are suppressed, wettability is excellent, and in which a temperature difference between liquidus temperature and solidus temperature is small.

### BACKGROUND ART

In recent years, demand for smaller size and higher performance of electronic devices, such as CPUs (Central Processing Units), having solder joints is on the rise. In response thereto, electrodes for printed boards and electronic devices have to become accordingly smaller. Electronic devices are connected to printed boards by way of electrodes, and hence solder joints connecting them also have become smaller accompanying the electrode size reduction.

A solder paste is generally used to connect electronic devices and printed boards via such fine electrodes. The solder paste is supplied onto electrodes of printed boards by printing or the like. To print the solder paste, a metal mask provided with openings is placed on the printed board, and a squeegee is caused to move over the metal mask while being pressed against the metal mask, thereby applying the solder paste onto the electrodes on the printed board all at once through the openings of the metal mask. Thereafter, electronic components are placed on the solder paste, which has been printed on the printed board, such that the electronic components are held by the solder paste until soldering is completed.

In a case, for instance, where introduction into a reflow oven after placement of the electronic components on the printed board takes several hours, the shape of the solder paste obtained at the time of printing may, in some instances, fail to be maintained due to changes in the solder paste over time. This may give rise to tilting or defective joining of the electronic components. In a case of a purchased solder paste, such a solder paste is normally not entirely used up in one printing operation, and thus moderate viscosity of the solder paste exhibited at the start of production has to be maintained, so as not to impair printing performance.

In recent years, however, the printing area of solder paste has been decreasing as electrode sizes have become smaller, and hence the lapse of time until a purchased solder paste is used up have become longer. In a case where a solder paste, which is a mixture of a solder powder and a flux, is stored for a prolonged storage period of time, the viscosity of the solder paste may increase, depending on the storage situation, and the initial printing performance exhibited at the time of purchase may fail to be brought out.

In order to suppress changes in a solder paste over time, therefore, for instance Patent Document 1 discloses a solder alloy containing Sn, and one or two or more selected from the group consisting of Ag, Bi, Sb, Zn, In and Cu, and containing a predetermined amount of As. Patent Document 1 discloses a result to the effect that the viscosity after two weeks at 25° C. is less than 140% of the viscosity exhibited at the start of production.

### CITATION LIST

### Patent Document

Patent Document 1: Patent Publication JP-A-2015-98052

### SUMMARY

### Technical Problem

As pointed out above, Patent Document 1 discloses a solder alloy that can selectively contain six elements other than Sn and As. Patent Document 1 describes a result to the effect that meltability is poor when As content is high.

The meltability evaluated in Patent Document 1 appears to correspond to the wettability of molten solder. The meltability disclosed in Patent Document 1 is evaluated by observing, with a microscope, the appearance of a melt, and on the basis of the presence or absence of unmelted solder powder. That is because residual solder powder that does not melt completely is less prone to occur if the wettability of molten solder is high.

A highly active flux has to be generally used in order to enhance the wettability of molten solder. It is considered that in the flux disclosed in Patent Document 1 a highly active flux may be used in order to suppress degradation of wettability caused by As. However, a viscosity increase rate of the flux may augment when a highly active flux is used. In the light of the disclosure of Patent Document 1, the As content has to be increased for the purpose of suppressing the increase of the viscosity increase rate. In order for the solder paste disclosed in Patent Document 1 to exhibit a lower viscosity increase rate and excellent wettability, it is necessary to keep on increasing the activity of the flux and the As content, which leads to a vicious circle.

Demand for maintaining stable performance over long periods of time in solder pastes regardless of the usage environment and storage environment has been recently on the rise, as well as demand for higher wettability as solder joints become smaller. A vicious circle as described above may arise inevitably when attempting to meet the above recent demands using the solder paste disclosed in Patent Document 1.

In addition, mechanical characteristics and so forth of solder joints must be enhanced in order to join fine electrodes. Depending on an element, when the content of a given element increases, so does the liquidus temperature, and the difference between the liquidus temperature and the solidus temperature becomes wide, thereby giving rise to segregation at the time of solidification, which in turn results in formation of a non-uniform alloy structure. When the solder alloy has such an alloy structure, mechanical characteristics such as tensile strength are impaired and the solder alloy breaks easily on account of external stress. This problem has become more pronounced accompanying electrode miniaturization in recent years.

It is thus an object of the present invention to provide a solder alloy, a solder powder, a solder paste and a solder joint that utilizes the foregoing, which have high mechanical characteristics and in which changes in a paste over time are suppressed, wettability is excellent, and moreover in which a temperature difference between liquidus temperature and solidus temperature is small.

### Solution to Problem

In improving simultaneously changes of a paste over time and achieving excellent wettability, it is necessary to elude the vicious circle derived from the use of a flux having high activity and from the increase in As content. The inventors focused on alloy compositions of solder powders, and conducted diligent research on achieving suppression of paste changes over time as well as excellent wettability, regardless of the type of the flux.

The present inventors studied, first, solder powders having a basic composition of Sn, SnCu or SnAgCu solder alloy used conventionally as solder alloys, with As being incorporated into the basic composition. The inventors assessed the As content, focusing on the underlying cause of suppression of changes in a solder paste over time in a case where such a solder powder is used.

It is considered that the rise in the viscosity of the solder paste over time is caused by reactions between the solder powder and the flux. A comparison between the results in Example 4 and Comparative example 2 in Table 1 of Patent Document 1 reveals that the viscosity increase rate is lower when the As content exceeds 100 mass ppm. In view of the above it was conjectured that As content may be further increased in a case where focus is on the effect of suppressing changes in a paste over time (hereafter also referred to as “thickening suppression effect”). It was found that although an increase in the As content elicits a slight thickening suppression effect along with a change in the As content, an excessive As content translates however into poorer wettability of the solder alloy.

The inventors inferred therefore that it is necessary to add an element, other than As, that elicits a thickening suppression effect, and assessed various elements; by chance, the inventors found that Bi and Pb elicit an effect similar to that of As. The underlying reason for this is unclear but is surmised to involve the following.

Given that the thickening suppression effect is brought out through suppression of reactions with the flux, examples of elements having low reactivity with fluxes include elements having a low ionization tendency. Generally, alloy ionization is thought of as ionization tendency, i.e. as the standard electrode potential, of the alloy composition. For example, a SnAg alloy containing Ag that is nobler than Sn ionizes less readily than Sn. Therefore, an alloy containing an element nobler than Sn ionizes less readily than Sn and may afford a higher thickening suppression effect of the solder paste.

Other than Sn, Ag and Cu, Patent Document 1 mentions Bi, Sb, Zn and In as equivalent elements, although In and Zn are less noble elements than Sn, in terms of ionization tendency. That is, Patent Document 1 indicates that a thickening suppression effect can be achieved even when adding an element that is less noble than Sn. It is therefore considered that a thickening suppression effect comparable or superior to that of the solder alloy disclosed in Patent Document 1 is elicited by a solder alloy that contains elements selected in accordance with ionization tendency. As pointed out above, moreover, wettability deteriorates as the As content increases.

The inventors assessed in detail Bi and Pb, which are found to have a thickening suppression effect. The wettability of a solder alloy, in a case where the heating temperature of the solder alloy is constant, is improved by Bi and Pb, since these elements lower the liquidus temperature of the solder alloy. However, the solidus temperature significantly drops, depending on the content of Bi and Pb, and as a result a temperature difference ΔT between the liquidus temperature and the solidus temperature becomes too wide. An excessively wide ΔT gives rise to segregation during solidification, which translates into impaired mechanical characteristics such as mechanical strength. This phenomenon of widening ΔT is conspicuous when Bi and Pb are added simultaneously, and accordingly calls for strict management.

It was considered that it is necessary to manage comprehensively the contents of As, Bi and Pb, instead of managing the contents of these elements individually, in order to achieve superior results as regards all of eliciting a thickening suppression effect, affording excellent wettability, and narrowing ΔT, in Sn, SnCu solder alloys, and SnAgCu solder alloys. As a result of diligent research on the contents of the above three elements, the inventors found by chance that a thickening suppression effect, wettability, and ΔT narrowing all exhibit superior results in a case where predetermined relational expressions are satisfied in which the contents of these elements lie within predetermined amount ranges, and perfected the present invention on the basis of that finding.

The present invention arrived at on the basis of that finding is as follows.

(1) A solder alloy having an alloy composition of As: 25 mass ppm to 300 mass ppm, Bi: 0 mass ppm or more and 25000 mass ppm or less, and Pb: more than 0 mass ppm and 8000 mass ppm or less, with a balance being made up of Sn, the solder alloy satisfying Expression (1) and Expression (2) below,

275≤2As+Bi+Pb (1)

0<2.3×10⁻⁴×Bi+8.2×10⁻⁴×Pb≤7 (2)

where in Expression (1) and Expression (2), As, Bi and Pb represent respectively contents (mass ppm) thereof in the alloy composition.

(2) The solder alloy according to (1), wherein the alloy composition further satisfies Expression (1a) below,

275≤2As+Bi+Pb≤25200 (1a)

where in Expression (1 a), As, Bi and Pb represent respectively contents (mass ppm) thereof in the alloy composition.

(3) The solder alloy according to (1), wherein the alloy composition further satisfies Expression (1b) below,

275≤2As+Bi+Pb≤5300 (1b)

where in Expression (1b), As, Bi and Pb represent respectively contents (mass ppm) thereof in the alloy composition.

(4) The solder alloy according to any one of (1) to (3), wherein the alloy composition further satisfies Expression (2a) below

0.02≤2.3×10⁻⁴×Bi+8.2×10⁻⁴×Pb≤0.9 (2a)

where in Expression (2a), Bi and Pb represent respectively contents (mass ppm) thereof in the alloy composition.

(5) The solder alloy according to any one of (1) to (4), wherein the alloy composition further contains at least one from among Ag: 0 mass % to 4 mass % and Cu: 0 mass % to 0.9 mass %.

(6) A solder powder comprising the solder alloy according to any one of (1) to (5).

(7) A solder paste comprising the solder powder according to (6).

(8) The solder paste according to (7) further comprising a zirconium oxide powder.

(9) The solder paste according to (8), comprising 0.05 mass % to 20.0 mass % of the zirconium oxide powder relative to a total mass of the solder paste.

(10) A solder joint comprising the solder alloy according to any one of (1) to (5).

### DESCRIPTION OF EMBODIMENTS

The present invention will be explained next in further detail. In the present specification, the term “ppm” pertaining to a solder alloy composition refers, unless otherwise noted, to “mass ppm”. Further, the notation “%” refers to “mass” unless otherwise indicated.

1. Alloy Composition

(1) As: 25 ppm to 300 ppm

Herein As is an element that allows suppressing changes in the viscosity of a solder paste over time. Further, As has low reactivity with fluxes and is a nobler element than Sn, and hence it is conjectured that As can elicit a thickening suppression effect. This thickening suppression effect cannot be sufficiently brought out when As is less than 25 ppm. The lower limit of As content is 25 ppm or more, preferably 50 ppm or more, and more preferably 100 ppm or more. On the other hand, the wettability of the solder alloy drops when As is excessive. The upper limit of the As content is 300 ppm or less, preferably 250 ppm or less, and more preferably 200 ppm or less.

(2) Bi: 0 ppm to 25000 ppm; Pb: more than 0 ppm up to 8000 ppm

Herein Bi and Pb are elements having low reactivity with fluxes and that exhibit a thickening suppression effect. These elements reduce the liquidus temperature of a solder alloy and reduce the viscosity of molten solder, and accordingly are elements that allow suppressing degradation of wettability caused by As.

Degradation of wettability caused by As can be suppressed by virtue of the presence of Pb, and optionally of Bi. The lower limit of Bi content in a case where the solder alloy according to the present invention contains Bi exceeds 0 ppm, and is preferably 25 ppm or more, more preferably 50 ppm or more, yet more preferably 75 ppm or more, particularly preferably 100 ppm or more, and most preferably 250 pp or more. The lower limit of Pb content exceeds 0 ppm, and is preferably 25 ppm or more, more preferably 50 ppm or more, yet more preferably 75 ppm or more, particularly preferably 100 ppm or more, and most preferably 250 ppm or more.

When the content of these elements is excessive, the solidus temperature drops significantly, and as a result ΔT, which is a temperature difference between the liquidus temperature and the solidus temperature, becomes excessively large. When ΔT is excessively large, a high-melting point crystal phase having a low content of Bi or Pb precipitates in the solidification process of molten solder, and Bi and/or Pb become concentrated as a result in the liquid phase. Thereafter, a low-melting point crystal phase having a high Bi or Pb concentration segregates when the temperature of the molten solder drops further. For instance, the mechanical strength of the solder alloy becomes impaired as a result. In particular crystal phases of high Bi concentration are hard and brittle, and hence the impairment of for instance mechanical strength upon segregation in the solder alloy is accordingly pronounced.

From this standpoint, the upper limit of Bi content, in a case where the solder alloy according to the present invention contains Bi, is 25000 ppm or less, preferably 10000 ppm or less, more preferably 1000 ppm or less, yet more preferably 600 ppm or less, particularly preferably 500 ppm or less. The upper limit of Pb content is 8000 ppm or less, preferably 5100 ppm or less, more preferably 5000 ppm or less, yet more preferably 1000 ppm or less, particularly preferably 850 ppm or less, most preferably 500 ppm or less.

(3) Expression (1)

The solder alloy according to the present invention must satisfy Expression (1) below.

275≤2As+Bi+Pb (1)

In Expression (1), As, Bi and Pb represent respective contents (mass ppm) thereof in the alloy composition.

All of As, Bi and Pb are elements exhibiting a thickening suppression effect. To suppress thickening, the total of the foregoing must be 230 ppm or more. The reason for doubling of the content of the As in Expression (1) is that the thickening suppression effect of As is higher than those of Bi and Pb.

A sufficient thickening suppression effect cannot be brought out when Expression (1) is less than 275. The lower limit of Expression (1) is 275 or more, preferably 300 or more, more preferably 700 or more, and yet more preferably 900 or more. By contrast the upper limit of (1) is not particularly restricted in terms of thickening suppression effect, but from the viewpoint of bringing ΔT into a suitable range, the upper limit of (1) is preferably 25200 or less, more preferably 15200 or less, yet more preferably 10200 or less, particularly preferably 8200 or less, most preferably 5300 or less.

The following Expressions (1a) and (1b) result from appropriately selecting upper limits and lower limits from among the above preferred implementations.

275≤2As+Bi+Pb≤25200 (1 a)

275≤2As+Bi+Pb≤5300 (1b)

In Expressions (1a) and (1b) As, Bi and Pb represent respective contents (mass ppm) thereof in the alloy composition.

(4) Expression (2)

The solder alloy according to the present invention must satisfy Expression (2) below.

0<2.3×10⁻⁴×Bi+8.2×10⁻⁴×Pb≤7 (2)

In Expression (2), Bi and Pb represent respective contents (mass ppm) thereof in the alloy composition.

Although Bi and Pb suppress degradation of wettability derived from the presence of As, an excessive content of Bi and Pb results however in a larger ΔT, and accordingly Bi and Pb must be managed strictly. In particular, ΔT increases readily in an alloy composition that contains Bi and Pb simultaneously. In the present invention, increases in ΔT can be suppressed by defining a total value resulting from multiplying the content of Bi and Pb by a predetermined coefficient. In Expression (2) the coefficient of Pb is larger than the coefficient of Bi. That is because the contribution of Pb in ΔT is larger than that of Bi, and ΔT increases significantly even upon a slight increase of Pb.

A solder alloy in which Expression (2) is zero contains neither of Bi and Pb, and thus degradation of wettability derived from the inclusion of As cannot be suppressed. The lower limit of Expression (2) exceeds 0, and is preferably 0.02 or more, more preferably 0.03 or more, yet more preferably 0.05 or more, particularly preferably 0.06 or more, and most preferably 0.11 or more. On the other hand when Expression (2) exceeds 7, the temperature region of ΔT becomes excessively wide, and accordingly a crystal phase of high concentration of Bi and/or Pb segregates at the time of solidification of the molten solder, and for instance mechanical strength becomes impaired. The upper limit of (2) is 7 or less, preferably 6.56 or less, more preferably 6.40 or less, yet more preferably 5.75 or less, even yet more preferably 4.18 or less, particularly preferably 2.30 or less, and most preferably 0.90 or less.

The following Expression (2a) results from appropriately selecting an upper limit and a lower limit from among the above preferred implementations.

0.02≤2.3×10⁻⁴×Bi+8.2×10⁻⁴×Pb≤0.9 (2a)

In Expression (2a), Bi and Pb represent respective contents (mass ppm) thereof in the alloy composition.

(4) At least one from among Ag: 0% to 4% and Cu: 0% to 0.9%

Herein Ag is an optional element capable of improving for instance the mechanical strength of the solder alloy through formation of Ag₃Sn at the crystal interface. Further, Ag is an element the ionization coefficient whereof is nobler than that of Sn; thus Ag promotes the thickening suppression effect by being co-present with As, Pb and Bi. The Ag content is preferably 0% to 4%, more preferably 0.5% to 3.5%, and yet more preferably 1.0% to 3.0%.

Further, Cu is an optional element that allows increasing the joint strength of solder joints. Herein Cu is an element the ionization coefficient whereof is nobler than that of Sn; thus Cu promotes the thickening suppression effect by being co-present with As, Pb and Bi. The Cu content is preferably 0% to 0.9%, more preferably 0.1% to 0.8% and yet more preferably 0.2% to 0.7%.

(5) Balance: Sn

The balance of the solder alloy according to the present invention is Sn. Besides the above-described elements, the solder alloy may contain unavoidable impurities. The above-described effect is not affected even if the solder alloy contains unavoidable impurities. The above-described effect is not influenced even when elements not contained in the present invention are present as unavoidable impurities, as described below. An excessive content of In results in a wider ΔT; hence the above-described effect is not influenced so long as the content of In is 1000 ppm or less.

2. Solder Powder

The solder powder according to the present invention is used in a solder paste described below. The solder powder according to the present invention preferably satisfies a size (particle size distribution) that conforms to symbols 1 to 8 in a powder size classification (Table 2) of JIS Z 3284-1:2014. More preferably, the solder powder according to the present invention has a size (particle size distribution) satisfying symbols 4 to 8, and yet more preferably a size (particle size distribution) satisfying symbols 5 to 8. When the particle size satisfies these conditions, the surface area of the powder is not excessively large, and increases in viscosity are curtailed; moreover, fine powder aggregation may be suppressed, thereby curtailing increases in viscosity. Soldering of finer parts becomes possible as a result.

3. Solder Paste

The solder paste according to the present invention contains the above-described solder powder, and a flux.

(1) Flux Components

The flux used in the solder paste is made up of any one of an organic acid, an amine, an amine hydrohalide salt, an organic halogen compound, a thixotropic agent, a rosin, a solvent, a surfactant, a base agent, a polymer compound, a silane coupling agent and a coloring agent, or is made up of a combination of two or more of the foregoing.

Examples of organic acids include succinic acid, glutaric acid, adipic acid, pimelic acid, suberic acid, azelaic acid, sebacic acid, dimer acids, propionic acid, 2,2-bis(hydroxymethyl) propionic acid, tartaric acid, malic acid, glycolic acid, diglycolic acid, thioglycolic acid, dithioglycolic acid, stearic acid, 12-hydroxystearic acid, palmitic acid and oleic acid.

Examples of amines include ethylamine, triethylamine, ethylenediamine, triethylenetetramine, 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, 1-benzyl-2-phenylimidazole, 1-cyanoethyl-2-methylimidazole, 1-cyanoethyl-2-undecylimidazole, 1-cyanoethyl-2-ethyl-4-methylimidazole, 1-cyanoethyl-2-phenylimidazole, 1-cyanoethyl-2-undecylimidazoliumtrimellitate, 1-cyanoethyl-2-phenylimidazoliumtrimellitate, 2,4-diamino-6-[2′-methylimidazolyl-(1′)]-ethyl-s-triazine, 2,4-diamino-6-[2′-undecylimidazolyl-(1′)]-ethyl-s-triazine, 2,4-diamino-6-[2′-ethyl-4′-methylimidazolyl-(1′)]-ethyl-s-triazine, 2,4-diamino-6-[2′-methylimidazolyl-(1′)]-ethyl-s-triazine isocyanuric acid adducts, 2-phenylimidazole isocyanuric acid adducts, 2-phenyl-4,5-dihydroxymethylimidazole, 2-phenyl-4-methyl-5-hydroxymethylimidazole, 2,3-dihydro-1H-pyrrolo[1,2-a]benzimidazole, 1-dodecyl-2-methyl-3-benzylimidazolium chloride, 2-methylimidazoline, 2-phenylimidazoline, 2,4-diamino-6-vinyl-s-triazine, 2,4-diamino-6-vinyl-s-triazine isocyanuric acid adducts, 2,4-diamino-6-methacryloyloxyethyl-s-triazine, epoxy-imidazole adducts, 2-methylbenzimidazole, 2-octylbenzimidazole, 2-pentylbenzimidazole, 2-(1-ethylpentyl)benzimidazole, 2-nonylbenzimidazole, 2-(4-thiazolyl)benzimidazole, benzimidazole, 2-(2′-hydroxy-5′-methylphenyl)benzotriazole, 2-(2′-hydroxy-3′-tert-butyl-5′-methylphenyl)-5-chlorobenzotriazole, 2-(2′-hydroxy-3′,5′-di-tert-amylphenyl)benzotriazole, 2-(2′-hydroxy-5′-tert-octylphenyl)benzotriazole, 2,2′-methylenebis [6-(2H-benzotriazole-2-yl)-4-tert-octylphenol], 6-(2-benzotriazolyl)-4-tert-octyl-6′-tert-butyl-4′-methyl-2,2′-methylenebis phenol, 1,2,3-benzotriazole, 1-[N,N-bis(2-ethylhexyl)aminomethyl]benzotriazole, carboxybenzotriazole, 1[N,N-bis(2-ethylhexyl)aminomethyl]methylbenzotriazole, 2,2′-[[(methyl-1H-benzotriazole-1-yl)methyl]imino]bisethanol, 1-(1′,2′-dicarboxyethyl)benzotriazole, 1-(2,3-dicarboxypropyl)benzotriazole, 1-[(2-ethylhexylamino)methyl]benzotriazole, 2,6-bis[(1H-benzotriazole-1-yl)methyl]-4-methylphenol, 5-methylbenzotriazole and 5-phenyltetrazole.

Amine hydrohalide salts are compounds resulting from a reaction between an amine and a hydrogen halide. Examples of the amine include ethylamine, ethylene diamine, triethylamine, methylimidazole and 2-ethyl-4-methylimidazole, while examples of the hydrogen halide include hydrides of chlorine, bromine and iodine.

Examples of organic halogen compounds include 1-bromo-2-butanol, 1-bromo-2-propanol, 3-bromo-1-propanol, 3-bromo-1,2-propanediol, 1,4-dibromo-2-butanol, 1,3-dibromo-2-propanol, 2,3-dibromo-1-propanol, 2,3-dibromo-1,4-butanediol and 2,3-dibromo-2-butene-1,4-diol.

Examples of thixotropic agents include wax-based thixotropic agents and amide-based thixotropic agents. Examples of wax-based thixotropic agents include for instance castor hydrogenated oil. Examples of amide-based thixotropic agents include lauric acid amide, palmitic acid amide, stearic acid amide, behenic acid amide, hydroxystearic acid amide, saturated fatty acid amides, oleic acid amide, erucic acid amide, unsaturated fatty acid amides, p-toluenemethane amide, aromatic amides, methylenebis stearic acid amide, ethylenebis lauric acid amide, ethylenebis hydroxystearic acid amide, saturated fatty acid bisamides, methylenebis oleic acid amide, unsaturated fatty acid bisamides, m-xylylenebis stearic acid amide, aromatic bisamides, saturated fatty acid polyamides, unsaturated fatty acid polyamides, aromatic polyamides, substituted amides, methylol stearic acid amide, methylol amide and fatty acid ester amides.

Examples of base agents include polyethylene glycol and rosin. Examples of rosin include for instance raw rosin such as gum rosin, wood rosin and tall oil rosin, and derivatives obtained from these raw rosins. Examples of the above derivatives include for instance purified rosin, hydrogenated rosin, disproportionated rosin, and polymerized rosin and α,β-unsaturated carboxylic acid-modified products (acrylated rosin, maleated rosin, fumarized rosin and the like), as well as purified products, hydrogenated products and disproportionated products of the above polymerized rosin, and purified products, hydrogenated products and disproportionated products of the above α,β-unsaturated carboxylic acid-modified products. Two or more types of the above can be used herein. In addition to the rosin-based resin there can be further incorporated at least one resin selected from among terpene resins, modified terpene resins, terpene phenolic resins, modified terpene phenolic resins, styrene resins, modified styrene resins, xylene resins and modified xylene resins. As the modified terpene resin there can be used for instance an aromatic-modified terpene resin, a hydrogenated terpene resin or a hydrogenated aromatic-modified terpene resin. As the modified terpene phenolic resin there can be used a hydrogenated terpene phenolic resin or the like. As the modified styrene resin there can be used a styrene acrylic resin, a styrene maleic acid resin or the like. Examples of modified xylene resins include phenol-modified xylene resins, alkylphenol-modified xylene resins, phenol-modified resole-type xylene resins, polyol modified xylene resins and polyoxyethylene-added xylene resins.

Examples of the solvent include water, alcohol-based solvents, glycol ether-based solvents and terpineols. Examples of alcohol-based solvents include isopropyl alcohol, 1,2-butanediol, isobornyl cyclohexanol, 2,4-diethyl-1,5-pentanediol, 2,2-dimethyl-1,3-propanediol, 2,5-dimethyl-2,5-hexanediol, 2,5-dimethyl-3-hexyne-2,5-diol, 2,3-dimethyl-2,3-butanediol, 1,1,1-tris(hydroxymethyl) ethane, 2-ethyl-2-hydroxymethyl-1,3-propanediol, 2,2′-oxybis(methylene)bis(2-ethyl-1,3-propanediol), 2,2-bis(hydroxymethyl)-1,3-propanediol, 1,2,6-trihydroxyhexane, bis[2,2,2-tris(hydroxymethyl)ethyl]ether, 1-ethynyl-1-cyclohexanol, 1,4-cyclohexanediol, 1,4-cyclohexanedimethanol, erythritol, threitol, guaiacol glycerol ether, 3,6-dimethyl-4-octyne-3,6-diol and 2,4,7,9-tetramethyl-5-decyne-4,7-diol. Examples of glycol ether-based solvent include diethylene glycol mono-2-ethylhexyl ether, ethylene glycol monophenyl ether, 2-methylpentane-2,4-diol, diethylene glycol monohexyl ether, diethylene glycol dibutyl ether and triethylene glycol monobutyl ether.

Examples of surfactants include polyoxyalkylene acetylene glycols, polyoxyalkylene glyceryl ether, polyoxyalkylene alkyl ether, polyoxyalkylene ester, polyoxyalkylene alkylamine and polyoxyalkylene alkylamide.

(2) Flux Content

The content of flux is preferably 5% to 95%, more preferably 5% to 15%, with respect to the total mass of the solder paste. Within the above ranges a thickening suppression effect derived from the solder powder is sufficiently brought out.

The solder paste according to the present invention preferably has a zirconium oxide powder.

(3) Zirconium Oxide Powder

The solder paste according to the present invention preferably contains a zirconium oxide powder. Zirconium oxide allows suppressing increases in paste viscosity accompanying changes over time. The underlying reason for this is presumably that the state of the oxide film on the solder powder surface prior to addition into the flux is preserved through incorporation of zirconium oxide. The details involved are unclear, but include conceivably the following. Active components of fluxes are ordinarily slightly active even at room temperature, and as a result, the surface oxide film on the solder powder becomes thinner on account of reduction; in turn, this causes powder particles to aggregate with one another. It is therefore conjectured that by adding zirconium oxide powder to the solder paste, active components in the flux react preferentially thereupon with the zirconium oxide powder, so that oxide film on the surface of the solder powder is sufficiently preserved so as to preclude aggregation.

In order to sufficiently bring out such an effect it is preferable that the content of zirconium oxide powder in the solder paste be 0.05% to 20.0% relative to the total mass of the solder paste. When the content is 0.05% or higher, the above effect can be elicited, and when the content is 20.0% or lower, the content of metal powder can be secured, and the thickening prevention effect can be brought out. The content of zirconium oxide is preferably 0.05% to 10.0%, and more preferably the content is 0.1% to 3%.

The particle size of the zirconium oxide powder in the solder paste is preferably 5 μm or less. Printability of the paste can be maintained when the particle size is 5 μm or less. The lower limit of particle size is not particularly restricted, but may be 0.5 μm or larger. The above particle size is an average value of equivalent diameters of projected circles worked out by image analysis of powder particles of 0.1 μm or more in captured images of SEM micrographs of the zirconium oxide powder.

The shape of the zirconium oxide is not particularly limited, however, contact area with the flux is larger, which results in a thickening suppression effect, if the zirconium oxide is odd-shaped. When the shape of the zirconium oxide is spherical, good flowability is obtained, and as a result there is elicited superior printability as a paste. The shape may be selected as appropriate depending on the desired characteristics.

(4) Method for Producing the Solder Paste

The solder paste according to the present invention is produced in accordance with a method generally resorted to in the relevant industry. To produce firstly the solder powder, a known method can be selected, for instance a dropping method for obtaining particles through dropping of a molten solder material, or a spraying method with centrifugal spraying, or a method that involves pulverizing a bulk solder material. Dropping and spraying in the dropping method and the spraying method are preferably carried out in an inert atmosphere or in a solvent, for the purpose of particle formation. The solder paste can then be produced by mixing the above components under heating to prepare a flux, and by introducing the solder powder, and optionally the zirconium oxide powder, into the flux, with stirring and mixing.

4. Solder Joint

The solder joint according to the present invention is suitable for being used for connection of an IC chip of a semiconductor package with a substrate (interposer) of the IC chip, and for connection of a semiconductor package and a printed wiring board. The term “solder joint” signifies a connection portion with an electrode.

5. Others

Besides being used as the above-described solder powder, the solder alloy according to the present invention may also be used in the form of wires.

The method for forming a solder joint according to the present invention may be a conventional method.

A joining method that utilizes the solder paste according to the present invention may be carried out for instance in accordance with a conventional method that relies on a reflow method. The melting temperature of the solder alloy in the case of flow soldering may be a temperature that is about 20° C. higher than the liquidus temperature. In the case of joining using the solder alloy according to the present invention, the cooling rate at the time of solidification is preferably factored in, from the viewpoint of obtaining a finer structure. For instance, the solder joint is cooled at a cooling rate of 2° C./s to 3° C./s or higher. Other joining conditions can be adjusted as appropriate in accordance with the alloy composition of the solder alloy.

The solder alloy according to the present invention can be produced in the form of a low-α-dose alloy by using a low-α-dose material as the starting material of the solder alloy. Such low-α-dose alloys allow suppressing soft errors when used for forming solder bumps around memories.

### EXAMPLES

The present invention will be explained next by way of examples, but is not meant to be limited to the examples below.

A flux prepared with 42 parts by mass of a rosin, 35 parts by mass of a glycol-based solvent, 8 parts by mass of a thixotropic agent, 10 parts by mass of an organic acid, 2 parts by mass of an amine, 3 parts by mass of a halogen, plus respective solder powders containing the alloy compositions given Table 1 to Table 6 and having a size (particle size distribution) satisfying symbol 4 in the classification (Table 2) of powder size in JIS Z 3284-1:2014, were mixed, to produce respective solder pastes. The mass ratio of the flux and the respective solder powder is herein flux:solder powder=11:89. The change over time of the viscosity of each solder paste was measured. The liquidus temperature and solidus temperature of each solder powder was also measured. Wettability was evaluated using the solder paste immediately after having been produced. Details are as follows.

Change Over Time

The viscosity of each solder paste immediately after having been produced was measured at a rotational speed of 10 rpm, at 25° C., in the atmosphere, for 12 hours, using PCU-205 by Malcom Co., Ltd. The viscosity was evaluated as “0” (good), deemed to afford a sufficient thickening suppression effect, if the viscosity after 12 hours was 1.2 times or less the viscosity at a time where 30 minutes had elapsed from production of the solder paste, and was evaluated as “X” (poor) in a case where the viscosity after 12 hours exceeded the above 1.2 times.

ΔT

Herein a DSC measurement was carried out on each solder powder prior to mixing with the flux, using EXSTAR DSC 7020 by SII Nano Technology Inc., with a sample amount of about 30 mg, and a rate of temperature rise of 15° C./min, to obtain a solidus temperature and a liquidus temperature. The solidus temperature was subtracted from the obtained liquidus temperature, to yield ΔT. Herein ΔT was evaluated as “O” (good) in a case where ΔT was equal to or smaller than 10° C., and as “X” (poor) in a case where ΔT exceeded 10° C.

Wettability

Each solder paste immediately after being produced was printed on a Cu plate, was heated from 25° C. to 260° C. at a rate of temperature rise of 1° C./s in a N2 atmosphere in a reflow oven, and was then cooled down to room temperature. The appearance of the cooled solder bumps was observed using an optical microscope, to evaluate wettability. Instances of no observed unmelted solder powder were evaluated as “O” (good), while instances of observed unmelted solder powder were evaluated as “X” (poor).

Evaluation results are given in Table 1.

TABLE 1

| | | | | | | | Evaluation item | | | |
|---|---|---|---|---|---|---|---|---|---|---|
| | | | | | | | | | | Compre- |
| | Alloy composition (mass ppm) | | | | Expres- | Expres- | Change | | | hensive |
| | Sn | As | Bi | Pb | sion (1) | sion (2) | over time | ΔT | Wettability | evaluation |
| Ref. Ex. 1 | Bal | 100 | 75 | 0 | 275 | 0.02 | ◯ | ◯ | ◯ | ◯ |
| Ex. 2 | Bal | 100 | 0 | 75 | 275 | 0.06 | ◯ | ◯ | ◯ | ◯ |
| Ex. 3 | Bal | 100 | 50 | 50 | 300 | 0.05 | ◯ | ◯ | ◯ | ◯ |
| Ex. 4 | Bal | 300 | 300 | 300 | 1200 | 0.32 | ◯ | ◯ | ◯ | ◯ |
| Ex. 5 | Bal | 200 | 250 | 250 | 900 | 0.26 | ◯ | ◯ | ◯ | ◯ |
| Ex. 6 | Bal | 100 | 250 | 250 | 700 | 0.26 | ◯ | ◯ | ◯ | ◯ |
| Ex. 7 | Bal | 200 | 600 | 850 | 1850 | 0.84 | ◯ | ◯ | ◯ | ◯ |
| Ex. 8 | Bal | 200 | 500 | 500 | 1400 | 0.53 | ◯ | ◯ | ◯ | ◯ |
| Ref. Ex. 9 | Bal | 200 | 1000 | 0 | 1400 | 0.23 | ◯ | ◯ | ◯ | ◯ |
| Ex. 10 | Bal | 200 | 0 | 1000 | 1400 | 0.82 | ◯ | ◯ | ◯ | ◯ |
| Ex. 11 | Bal | 25 | 350 | 1000 | 1400 | 0.90 | ◯ | ◯ | ◯ | ◯ |
| Ex. 12 | Bal | 100 | 0 | 5100 | 5300 | 4.18 | ◯ | ◯ | ◯ | ◯ |
| Ex. 13 | Bal | 100 | 0 | 8000 | 8200 | 6.56 | ◯ | ◯ | ◯ | ◯ |
| Ref. Ex. 14 | Bal | 100 | 10000 | 0 | 10200 | 2.30 | ◯ | ◯ | ◯ | ◯ |
| Ex. 15 | Bal | 100 | 10000 | 5000 | 15200 | 6.40 | ◯ | ◯ | ◯ | ◯ |
| Ref. Ex. 16 | Bal | 100 | 25000 | 0 | 25200 | 5.75 | ◯ | ◯ | ◯ | ◯ |
| Com. Ex. 1 | Bal. | 0 | 100 | 100 | 200 | 0.11 | X | ◯ | ◯ | X |
| Com. Ex. 2 | Bal | 25 | 25 | 25 | 100 | 0.03 | X | ◯ | ◯ | X |
| Com. Ex. 3 | Bal | 350 | 25 | 25 | 750 | 0.03 | ◯ | ◯ | X | X |
| Com. Ex. 4 | Bal | 800 | 100 | 100 | 1800 | 0.11 | ◯ | ◯ | X | X |
| Com. Ex. 5 | Bal | 100 | 0 | 10000 | 10200 | 8.20 | ◯ | X | ◯ | X |
| Com. Ex. 6 | Bal | 100 | 20000 | 5000 | 25200 | 8.70 | ◯ | X | ◯ | X |
| Com. Ex. 7 | Bal | 100 | 25000 | 25000 | 50200 | 26.25 | ◯ | X | ◯ | X |
| Com. Ex. 8 | Bal | 100 | 50000 | 0 | 50200 | 11.50 | ◯ | X | ◯ | X |
| Com. Ex. 9 | Bal | 100 | 0 | 50000 | 50200 | 41.00 | ◯ | X | ◯ | X |

Underlining denotes values outside the scope of the invention.

TABLE 2

| | | | | | | | | Evaluation item | | | |
|---|---|---|---|---|---|---|---|---|---|---|---|
| | Alloy composition (As, Bi, Pb: mass ppm, | | | | | | | | | | Compre- |
| | Cu: mass%) | | | | | Expres- | Expres- | Change | | | hensive |
| | Sn | Cu | As | Bi | Pb | sion (1) | sion (2) | over time | ΔT | Wettability | evaluation |
| Ref. Ex. 17 | Bal | 0.7 | 100 | 75 | 0 | 275 | 0.02 | ◯ | ◯ | ◯ | ◯ |
| Ex. 18 | Bal | 0.7 | 100 | 0 | 75 | 275 | 0.06 | ◯ | ◯ | ◯ | ◯ |
| Ex. 19 | Bal | 0.7 | 100 | 50 | 50 | 300 | 0.05 | ◯ | ◯ | ◯ | ◯ |
| Ex. 20 | Bal | 0.7 | 300 | 300 | 300 | 1200 | 0.32 | ◯ | ◯ | ◯ | ◯ |
| Ex. 21 | Bal | 0.7 | 200 | 250 | 250 | 900 | 0.26 | ◯ | ◯ | ◯ | ◯ |
| Ex. 22 | Bal | 0.7 | 100 | 250 | 250 | 700 | 0.26 | ◯ | ◯ | ◯ | ◯ |
| Ex. 23 | Bal | 0.7 | 200 | 600 | 850 | 1850 | 0.84 | ◯ | ◯ | ◯ | ◯ |
| Ex. 24 | Bal | 0.7 | 200 | 500 | 500 | 1400 | 0.53 | ◯ | ◯ | ◯ | ◯ |
| Ref. Ex. 25 | Bal | 0.7 | 200 | 1000 | 0 | 1400 | 0.23 | ◯ | ◯ | ◯ | ◯ |
| Ex. 26 | Bal | 0.7 | 200 | 0 | 1000 | 1400 | 0.82 | ◯ | ◯ | ◯ | ◯ |
| Ex. 27 | Bal | 0.7 | 25 | 350 | 1000 | 1400 | 0.90 | ◯ | ◯ | ◯ | ◯ |
| Ex. 28 | Bal | 0.7 | 100 | 0 | 5100 | 5300 | 4.18 | ◯ | ◯ | ◯ | ◯ |
| Ex. 29 | Bal | 0.7 | 100 | 0 | 8000 | 8200 | 6.56 | ◯ | ◯ | ◯ | ◯ |
| Ref. Ex. 30 | Bal | 0.7 | 100 | 10000 | 0 | 10200 | 2.30 | ◯ | ◯ | ◯ | ◯ |
| Ex. 31 | Bal | 0.7 | 100 | 10000 | 5000 | 15200 | 6.40 | ◯ | ◯ | ◯ | ◯ |
| Ref. Ex. 32 | Bal | 0.7 | 100 | 25000 | 0 | 25200 | 5.75 | ◯ | ◯ | ◯ | ◯ |
| Com. Ex. 10 | Bal. | 0.7 | 0 | 100 | 100 | 200 | 0.11 | X | ◯ | ◯ | X |
| Com. Ex. 11 | Bal | 0.7 | 25 | 25 | 25 | 100 | 0.03 | X | ◯ | ◯ | X |
| Com. Ex. 12 | Bal | 0.7 | 350 | 25 | 25 | 750 | 0.03 | ◯ | ◯ | X | X |
| Com. Ex. 13 | Bal | 0.7 | 800 | 100 | 100 | 1800 | 0.11 | ◯ | ◯ | X | X |
| Com. Ex. 14 | Bal | 0.7 | 100 | 0 | 10000 | 10200 | 8.20 | ◯ | X | ◯ | X |
| Com. Ex. 15 | Bal | 0.7 | 100 | 20000 | 5000 | 25200 | 8.70 | ◯ | X | ◯ | X |
| Com. Ex. 16 | Bal | 0.7 | 100 | 25000 | 25000 | 50200 | 26.25 | ◯ | X | ◯ | X |
| Com. Ex. 17 | Bal | 0.7 | 100 | 50000 | 0 | 50200 | 11.50 | ◯ | X | ◯ | X |
| Com. Ex. 18 | Bal | 0.7 | 100 | 0 | 50000 | 50200 | 41.00 | ◯ | X | ◯ | X |

Underlining denotes values outside the scope of the invention.

TABLE 3

| | | | | | | | | | Evaluation item | | | |
|---|---|---|---|---|---|---|---|---|---|---|---|---|
| | Alloy composition (As, Bi, Pb: mass ppm; | | | | | | | | | | | Compre- |
| | Ag, Cu: mass%) | | | | | | Expres- | Expres- | Change | | | hensive |
| | Sn | Ag | Cu | As | Bi | Pb | sion (1) | sion (2) | over time | ΔT | Wettability | evaluation |
| Ref. Ex. 33 | Bal | 1 | 0.5 | 100 | 75 | 0 | 275 | 0.02 | ◯ | ◯ | ◯ | ◯ |
| Ex. 34 | Bal | 1 | 0.5 | 100 | 0 | 75 | 275 | 0.06 | ◯ | ◯ | ◯ | ◯ |
| Ex. 35 | Bal | 1 | 0.5 | 100 | 50 | 50 | 300 | 0.05 | ◯ | ◯ | ◯ | ◯ |
| Ex. 36 | Bal | 1 | 0.5 | 300 | 300 | 300 | 1200 | 0.32 | ◯ | ◯ | ◯ | ◯ |
| Ex. 37 | Bal | 1 | 0.5 | 200 | 250 | 250 | 900 | 0.26 | ◯ | ◯ | ◯ | ◯ |
| Ex. 38 | Bal | 1 | 0.5 | 100 | 250 | 250 | 700 | 0.26 | ◯ | ◯ | ◯ | ◯ |
| Ex. 39 | Bal | 1 | 0.5 | 200 | 600 | 850 | 1850 | 0.84 | ◯ | ◯ | ◯ | ◯ |
| Ex. 40 | Bal | 1 | 0.5 | 200 | 500 | 500 | 1400 | 0.53 | ◯ | ◯ | ◯ | ◯ |
| Ref. Ex. 41 | Bal | 1 | 0.5 | 200 | 1000 | 0 | 1400 | 0.23 | ◯ | ◯ | ◯ | ◯ |
| Ex. 42 | Bal | 1 | 0.5 | 200 | 0 | 1000 | 1400 | 0.82 | ◯ | ◯ | ◯ | ◯ |
| Ex. 43 | Bal | 1 | 0.5 | 25 | 350 | 1000 | 1400 | 0.90 | ◯ | ◯ | ◯ | ◯ |
| Ex. 44 | Bal | 1 | 0.5 | 100 | 0 | 5100 | 5300 | 4.18 | ◯ | ◯ | ◯ | ◯ |
| Ex. 45 | Bal | 1 | 0.5 | 100 | 0 | 8000 | 8200 | 6.56 | ◯ | ◯ | ◯ | ◯ |
| Ref. Ex. 46 | Bal | 1 | 0.5 | 100 | 10000 | 0 | 10200 | 2.30 | ◯ | ◯ | ◯ | ◯ |
| Ex. 47 | Bal | 1 | 0.5 | 100 | 10000 | 5000 | 15200 | 6.40 | ◯ | ◯ | ◯ | ◯ |
| Ref. Ex. 48 | Bal | 1 | 0.5 | 100 | 25000 | 0 | 25200 | 5.75 | ◯ | ◯ | ◯ | ◯ |
| Com. Ex. 19 | Bal. | 1 | 0.5 | 0 | 100 | 100 | 200 | 0.11 | X | ◯ | ◯ | X |
| Com. Ex. 20 | Bal | 1 | 0.5 | 25 | 25 | 25 | 100 | 0.03 | X | ◯ | ◯ | X |
| Com. Ex. 21 | Bal | 1 | 0.5 | 350 | 25 | 25 | 750 | 0.03 | ◯ | ◯ | X | X |
| Com. Ex. 22 | Bal | 1 | 0.5 | 800 | 100 | 100 | 1800 | 0.11 | ◯ | ◯ | X | X |
| Com. Ex. 23 | Bal | 1 | 0.5 | 100 | 0 | 10000 | 10200 | 8.20 | ◯ | X | ◯ | X |
| Com. Ex. 24 | Bal | 1 | 0.5 | 100 | 20000 | 5000 | 25200 | 8.70 | ◯ | X | ◯ | X |
| Com. Ex. 25 | Bal | 1 | 0.5 | 100 | 25000 | 25000 | 50200 | 26.25 | ◯ | X | ◯ | X |
| Com. Ex. 26 | Bal | 1 | 0.5 | 100 | 50000 | 0 | 50200 | 11.50 | ◯ | X | ◯ | X |
| Com. Ex. 27 | Bal | 1 | 0.5 | 100 | 0 | 50000 | 50200 | 41.00 | ◯ | X | ◯ | X |

Underlining denotes values outside the scope of the invention.

TABLE 4

| | | | | | | | | | Evaluation item | | | |
|---|---|---|---|---|---|---|---|---|---|---|---|---|
| | Alloy composition (As, Bi, Pb: mass ppm; | | | | | | | | | | | Compre- |
| | Ag, Cu: mass%) | | | | | | Expres- | Expres- | Change | | | hensive |
| | Sn | Ag | Cu | As | Bi | Pb | sion (1) | sion (2) | over time | ΔT | Wettability | evaluation |
| Ref. Ex. 49 | Bal | 2 | 0.5 | 100 | 75 | 0 | 275 | 0.02 | ◯ | ◯ | ◯ | ◯ |
| Ex. 50 | Bal | 2 | 0.5 | 100 | 0 | 75 | 275 | 0.06 | ◯ | ◯ | ◯ | ◯ |
| Ex. 51 | Bal | 2 | 0.5 | 100 | 50 | 50 | 300 | 0.05 | ◯ | ◯ | ◯ | ◯ |
| Ex. 52 | Bal | 2 | 0.5 | 300 | 300 | 300 | 1200 | 0.32 | ◯ | ◯ | ◯ | ◯ |
| Ex. 53 | Bal | 2 | 0.5 | 200 | 250 | 250 | 900 | 0.26 | ◯ | ◯ | ◯ | ◯ |
| Ex. 54 | Bal | 2 | 0.5 | 100 | 250 | 250 | 700 | 0.26 | ◯ | ◯ | ◯ | ◯ |
| Ex. 55 | Bal | 2 | 0.5 | 200 | 600 | 850 | 1850 | 0.84 | ◯ | ◯ | ◯ | ◯ |
| Ex. 56 | Bal | 2 | 0.5 | 200 | 500 | 500 | 1400 | 0.53 | ◯ | ◯ | ◯ | ◯ |
| Ref. Ex. 57 | Bal | 2 | 0.5 | 200 | 1000 | 0 | 1400 | 0.23 | ◯ | ◯ | ◯ | ◯ |
| Ex. 58 | Bal | 2 | 0.5 | 200 | 0 | 1000 | 1400 | 0.82 | ◯ | ◯ | ◯ | ◯ |
| Ex. 59 | Bal | 2 | 0.5 | 25 | 350 | 1000 | 1400 | 0.90 | ◯ | ◯ | ◯ | ◯ |
| Ex. 60 | Bal | 2 | 0.5 | 100 | 0 | 5100 | 5300 | 4.18 | ◯ | ◯ | ◯ | ◯ |
| Ex. 61 | Bal | 2 | 0.5 | 100 | 0 | 8000 | 8200 | 6.56 | ◯ | ◯ | ◯ | ◯ |
| Ref. Ex. 62 | Bal | 2 | 0.5 | 100 | 10000 | 0 | 10200 | 2.30 | ◯ | ◯ | ◯ | ◯ |
| Ex. 63 | Bal | 2 | 0.5 | 100 | 10000 | 5000 | 15200 | 6.40 | ◯ | ◯ | ◯ | ◯ |
| Ref. Ex. 64 | Bal | 2 | 0.5 | 100 | 25000 | 0 | 25200 | 5.75 | ◯ | ◯ | ◯ | ◯ |
| Com. Ex. 28 | Bal. | 2 | 0.5 | 0 | 100 | 100 | 200 | 0.11 | X | ◯ | ◯ | X |
| Com. Ex. 29 | Bal | 2 | 0.5 | 25 | 25 | 25 | 100 | 0.03 | X | ◯ | ◯ | X |
| Com. Ex. 30 | Bal | 2 | 0.5 | 350 | 25 | 25 | 750 | 0.03 | ◯ | ◯ | X | X |
| Com. Ex. 31 | Bal | 2 | 0.5 | 800 | 100 | 100 | 1800 | 0.11 | ◯ | ◯ | X | X |
| Com. Ex. 32 | Bal | 2 | 0.5 | 100 | 0 | 10000 | 10200 | 8.20 | ◯ | X | ◯ | X |
| Com. Ex. 33 | Bal | 2 | 0.5 | 100 | 20000 | 5000 | 25200 | 8.70 | ◯ | X | ◯ | X |
| Com. Ex. 34 | Bal | 2 | 0.5 | 100 | 25000 | 25000 | 50200 | 26.25 | ◯ | X | ◯ | X |
| Com. Ex. 35 | Bal | 2 | 0.5 | 100 | 50000 | 0 | 50200 | 11.50 | ◯ | X | ◯ | X |
| Com. Ex. 36 | Bal | 2 | 0.5 | 100 | 0 | 50000 | 50200 | 41.00 | ◯ | X | ◯ | X |

Underlining denotes values outside the scope of the invention.

TABLE 5

| | | | | | | | | | Evaluation item | | | |
|---|---|---|---|---|---|---|---|---|---|---|---|---|
| | Alloy composition (As, Bi, Pb: mass ppm; | | | | | | | | | | | Compre- |
| | Ag, Cu: mass%) | | | | | | Expres- | Expres- | Change | | | hensive |
| | Sn | Ag | Cu | As | Bi | Pb | sion (1) | sion (2) | over time | ΔT | Wettability | evaluation |
| Ref. Ex. 65 | Bal | 3 | 0.5 | 100 | 75 | 0 | 275 | 0.02 | ◯ | ◯ | ◯ | ◯ |
| Ex. 66 | Bal | 3 | 0.5 | 100 | 0 | 75 | 275 | 0.06 | ◯ | ◯ | ◯ | ◯ |
| Ex. 67 | Bal | 3 | 0.5 | 100 | 50 | 50 | 300 | 0.05 | ◯ | ◯ | ◯ | ◯ |
| Ex. 68 | Bal | 3 | 0.5 | 300 | 300 | 300 | 1200 | 0.32 | ◯ | ◯ | ◯ | ◯ |
| Ex. 69 | Bal | 3 | 0.5 | 200 | 250 | 250 | 900 | 0.26 | ◯ | ◯ | ◯ | ◯ |
| Ex. 70 | Bal | 3 | 0.5 | 100 | 250 | 250 | 700 | 0.26 | ◯ | ◯ | ◯ | ◯ |
| Ex. 71 | Bal | 3 | 0.5 | 200 | 600 | 850 | 1850 | 0.84 | ◯ | ◯ | ◯ | ◯ |
| Ex. 72 | Bal | 3 | 0.5 | 200 | 500 | 500 | 1400 | 0.53 | ◯ | ◯ | ◯ | ◯ |
| Ref. Ex. 73 | Bal | 3 | 0.5 | 200 | 1000 | 0 | 1400 | 0.23 | ◯ | ◯ | ◯ | ◯ |
| Ex. 74 | Bal | 3 | 0.5 | 200 | 0 | 1000 | 1400 | 0.82 | ◯ | ◯ | ◯ | ◯ |
| Ex. 75 | Bal | 3 | 0.5 | 25 | 350 | 1000 | 1400 | 0.90 | ◯ | ◯ | ◯ | ◯ |
| Ex. 76 | Bal | 3 | 0.5 | 100 | 0 | 5100 | 5300 | 4.18 | ◯ | ◯ | ◯ | ◯ |
| Ex. 77 | Bal | 3 | 0.5 | 100 | 0 | 8000 | 8200 | 6.56 | ◯ | ◯ | ◯ | ◯ |
| Ref. Ex. 78 | Bal | 3 | 0.5 | 100 | 10000 | 0 | 10200 | 2.30 | ◯ | ◯ | ◯ | ◯ |
| Ex. 79 | Bal | 3 | 0.5 | 100 | 10000 | 5000 | 15200 | 6.40 | ◯ | ◯ | ◯ | ◯ |
| Ref. Ex. 80 | Bal | 3 | 0.5 | 100 | 25000 | 0 | 25200 | 5.75 | ◯ | ◯ | ◯ | ◯ |
| Com. Ex. 37 | Bal. | 3 | 0.5 | 0 | 100 | 100 | 200 | 0.11 | X | ◯ | ◯ | X |
| Com. Ex. 38 | Bal | 3 | 0.5 | 25 | 25 | 25 | 100 | 0.03 | X | ◯ | ◯ | X |
| Com. Ex. 39 | Bal | 3 | 0.5 | 350 | 25 | 25 | 750 | 0.03 | ◯ | ◯ | X | X |
| Com. Ex. 40 | Bal | 3 | 0.5 | 800 | 100 | 100 | 1800 | 0.11 | ◯ | ◯ | X | X |
| Com. Ex. 41 | Bal | 3 | 0.5 | 100 | 0 | 10000 | 10200 | 8.20 | ◯ | X | ◯ | X |
| Com. Ex. 42 | Bal | 3 | 0.5 | 100 | 20000 | 5000 | 25200 | 8.70 | ◯ | X | ◯ | X |
| Com. Ex. 43 | Bal | 3 | 0.5 | 100 | 25000 | 25000 | 50200 | 26.25 | ◯ | X | ◯ | X |
| Com. Ex. 44 | Bal | 3 | 0.5 | 100 | 50000 | 0 | 50200 | 11.50 | ◯ | X | ◯ | X |
| Com. Ex. 45 | Bal | 3 | 0.5 | 100 | 0 | 50000 | 50200 | 41.00 | ◯ | X | ◯ | X |

Underlining denotes values outside the scope of the invention.

TABLE 6

| | | | | | | | | | Evaluation item | | | |
|---|---|---|---|---|---|---|---|---|---|---|---|---|
| | Alloy composition (As, Bi, Pb: mass ppm; | | | | | | | | | | | Compre- |
| | Ag, Cu: mass%) | | | | | | Expres- | Expres- | Change | | | hensive |
| | Sn | Ag | Cu | As | Bi | Pb | sion (1) | sion (2) | over time | ΔT | Wettability | evaluation |
| Ref. Ex. 81 | Bal | 3.5 | 0.5 | 100 | 75 | 0 | 275 | 0.02 | ◯ | ◯ | ◯ | ◯ |
| Ex. 82 | Bal | 3.5 | 0.5 | 100 | 0 | 75 | 275 | 0.06 | ◯ | ◯ | ◯ | ◯ |
| Ex. 83 | Bal | 3.5 | 0.5 | 100 | 50 | 50 | 300 | 0.05 | ◯ | ◯ | ◯ | ◯ |
| Ex. 84 | Bal | 3.5 | 0.5 | 300 | 300 | 300 | 1200 | 0.32 | ◯ | ◯ | ◯ | ◯ |
| Ex. 85 | Bal | 3.5 | 0.5 | 200 | 250 | 250 | 900 | 0.26 | ◯ | ◯ | ◯ | ◯ |
| Ex. 86 | Bal | 3.5 | 0.5 | 100 | 250 | 250 | 700 | 0.26 | ◯ | ◯ | ◯ | ◯ |
| Ex. 87 | Bal | 3.5 | 0.5 | 200 | 600 | 850 | 1850 | 0.84 | ◯ | ◯ | ◯ | ◯ |
| Ex. 88 | Bal | 3.5 | 0.5 | 200 | 500 | 500 | 1400 | 0.53 | ◯ | ◯ | ◯ | ◯ |
| Ref. Ex. 89 | Bal | 3.5 | 0.5 | 200 | 1000 | 0 | 1400 | 0.23 | ◯ | ◯ | ◯ | ◯ |
| Ex. 90 | Bal | 3.5 | 0.5 | 200 | 0 | 1000 | 1400 | 0.82 | ◯ | ◯ | ◯ | ◯ |
| Ex. 91 | Bal | 3.5 | 0.5 | 25 | 350 | 1000 | 1400 | 0.90 | ◯ | ◯ | ◯ | ◯ |
| Ex. 92 | Bal | 3.5 | 0.5 | 100 | 0 | 5100 | 5300 | 4.18 | ◯ | ◯ | ◯ | ◯ |
| Ex. 93 | Bal | 3.5 | 0.5 | 100 | 0 | 8000 | 8200 | 6.56 | ◯ | ◯ | ◯ | ◯ |
| Ref. Ex. 94 | Bal | 3.5 | 0.5 | 100 | 10000 | 0 | 10200 | 2.30 | ◯ | ◯ | ◯ | ◯ |
| Ex. 95 | Bal | 3.5 | 0.5 | 100 | 10000 | 5000 | 15200 | 6.40 | ◯ | ◯ | ◯ | ◯ |
| Ref. Ex. 96 | Bal | 3.5 | 0.5 | 100 | 25000 | 0 | 25200 | 5.75 | ◯ | ◯ | ◯ | ◯ |
| Com. Ex. 46 | Bal. | 3.5 | 0.5 | 0 | 100 | 100 | 200 | 0.11 | X | ◯ | ◯ | X |
| Com. Ex. 47 | Bal | 3.5 | 0.5 | 25 | 25 | 25 | 100 | 0.03 | X | ◯ | ◯ | X |
| Com. Ex. 48 | Bal | 3.5 | 0.5 | 350 | 25 | 25 | 750 | 0.03 | ◯ | ◯ | X | X |
| Com. Ex. 49 | Bal | 3.5 | 0.5 | 800 | 100 | 100 | 1800 | 0.11 | ◯ | ◯ | X | X |
| Com. Ex. 50 | Bal | 3.5 | 0.5 | 100 | 0 | 10000 | 10200 | 8.20 | ◯ | X | ◯ | X |
| Com. Ex. 51 | Bal | 3.5 | 0.5 | 100 | 20000 | 5000 | 25200 | 8.70 | ◯ | X | ◯ | X |
| Com. Ex. 52 | Bal | 3.5 | 0.5 | 100 | 25000 | 25000 | 50200 | 26.25 | ◯ | X | ◯ | X |
| Com. Ex. 53 | Bal | 3.5 | 0.5 | 100 | 50000 | 0 | 50200 | 11.50 | ◯ | X | ◯ | X |
| Com. Ex. 54 | Bal | 3.5 | 0.5 | 100 | 0 | 50000 | 50200 | 41.00 | ◯ | X | ◯ | X |

Underlining denotes values outside the scope of the invention.

Tables 1 to 6 reveal that all the alloy compositions in the examples satisfied all the requirements of the present invention, and therefore exhibited a thickening suppression effect, narrowing of ΔT, and excellent wettability.

By contrast, Comparative examples 1, 10, 19, 28, 37 and 46 did not contain As, and hence exhibited no thickening suppression effect.

In Comparative examples 2, 11, 20, 29, 38 and 47, Expression (1) was below the lower limit, and accordingly no thickening suppression effect was elicited.

In Comparative examples 3, 4, 12, 13, 21, 22, 30, 31, 39, 40, 48 and 49, the As content exceeded the upper limit, and accordingly wettability results were poor.

In Comparative examples 5, 7, 9, 14, 16, 18, 23, 25, 27, 32, 34, 36, 41, 43, 45, 50, 52 and 54, the Pb content and Expression (2) exceeded respective upper limits, and as a result ΔT exceeded 10° C.

In Comparative examples 6, 15, 24, 33, 42 and 51, Expression (2) exceeded the upper limit, and as a result ΔT exceeded 10° C.

In Comparative examples 8, 17, 26, 35, 44 and 53, the Bi content and

Expression (2) exceeded respective upper limits, and as a result ΔT exceeded 10° C.

Also, improvement of the thickening suppression effect could be observed in examples where 0.1% of zirconium oxide powder having a particle size of 1 μm was incorporated.

1. A solder alloy comprising an alloy composition of As: 25 mass ppm to 300 mass ppm, Bi: 0 mass ppm or more and 25000 mass ppm or less, and Pb: more than 0 mass ppm and 8000 mass ppm or less, with a balance being made up of Sn, the solder alloy satisfying Expression (1) and Expression (2) below,
275≤2As+Bi+Pb (1)
0<2.3×10⁻⁴×Bi+8.2×10⁻⁴×Pb≤7 (2)
where in Expression (1) and Expression (2), As, Bi and Pb represent respectively contents (mass ppm) thereof in the alloy composition.

2. The solder alloy according to claim 1, wherein the alloy composition further satisfies Expression (1a) below,
275≤2As+Bi+Pb≤25200 (1a)
where in Expression (1a), As, Bi and Pb represent respectively contents (mass ppm) thereof in the alloy composition.

3. The solder alloy according to claim 1, wherein the alloy composition further satisfies Expression (1b) below,
275≤2As+Bi+Pb≤5300 (1b)
where in Expression (1b), As, Bi and Pb represent respectively contents (mass ppm) thereof in the alloy composition.

4. The solder alloy according to claim 1, wherein the alloy composition further satisfies Expression (2a) below,
0.02≤2.3×10⁻⁴×Bi+8.2×10⁻⁴×Pb≤0.9 (2a)
where in Expression (2a), Bi and Pb represent respectively contents (mass ppm) thereof in the alloy composition.

5. The solder alloy according to claim 1, wherein the alloy composition further comprises at least one from among Ag: 0 mass % to 4 mass % and Cu:
0 mass % to 0.9 mass %.

6. A solder powder comprising the solder alloy according to claim 1.

7. A solder paste comprising the solder powder according to claim 6.

8. The solder paste according to claim 7, further comprising a zirconium oxide powder.

9. The solder paste according to claim 8, comprising 0.05 mass % to 20.0 mass % of the zirconium oxide powder relative to a total mass of the solder paste.

10. A solder joint comprising the solder alloy according to claim 1.
